(19) United States
(12) Patent Application Publication
(10) Pub. No.: US 2025/0276246 A1
(43) Pub. Date: Sep. 4, 2025

(54) INFORMATION PROCESSING SYSTEM, NON-TRANSITORY COMPUTER-READABLE STORAGE MEDIUM HAVING INFORMATION PROCESSING PROGRAM STORED THEREIN, INFORMATION PROCESSING METHOD, AND INFORMATION PROCESSING APPARATUS

(71) Applicant: Nintendo Co., Ltd., Kyoto (JP)

(72) Inventors: Yui IIDA, Kyoto (JP); Masashi YAMAURA, Kyoto (JP); Hirofumi HATANO, Kyoto (JP); Munetaka TSUDA, Kyoto (JP)

(21) Appl. No.: 18/824,464

(22) Filed: Sep. 4, 2024

(30) Foreign Application Priority Data
Feb. 29, 2024 (JP) 2024-030373

(51) Int. Cl. A63F 13/69; A63F 13/44

(52) U.S. Cl. CPC A63F 13/69; A63F 13/44

(57) ABSTRACT

A processor gives points to a user if any of a plurality of giving conditions is achieved by the user, and gives a reward selected by the user from among a plurality of rewards, to the user in exchange for the points owned by the user. The plurality of giving conditions include a first giving condition achieved if a specific game is played, and the plurality of rewards include first rewards set in an initial state of being unselectable, and second rewards selectable without achieving the first giving condition. When the first giving condition is achieved, the processor updates the first reward corresponding to the specific game among the first rewards from the initial state of being unselectable by the user to a state of being selectable by the user.

### CROSS REFERENCE TO RELATED APPLICATION

This application claims priority to Japanese Patent Application No. 2024-030373 filed on Feb. 29, 2024, the entire contents of which are incorporated herein by reference.

### FIELD

The present disclosure relates to information processing in which points are given to a user when a predetermined giving condition is achieved and a reward can be given in exchange for the points.

### BACKGROUND AND SUMMARY

Hitherto, a technology has been known in which play conditions for acquiring items are set for each game, and when a play condition is satisfied, a reward item corresponding to the condition is given to a user.

In the game described above, when a certain play condition is satisfied, a reward item corresponding to the condition is given to the user regardless of whether the user wants the reward item or not. That is, the above reward item is automatically given even to a user who wants another reward item.

In view of the above, the following configuration examples are disclosed.

### Configuration 1

Configuration 1 is directed to an information processing system including a processor, the processor being configured to:
give points to a user if any of a plurality of giving conditions is achieved by the user;
give a reward selected by the user from among a plurality of rewards, to the user in exchange for the points owned by the user,
   the plurality of giving conditions including a first giving condition achieved if a specific game is played,
   the plurality of rewards including first rewards set in an initial state of being unselectable, and second rewards selectable without achieving the first giving condition; and
when the first giving condition is achieved, update the first reward corresponding to the specific game among the first rewards from the initial state of being unselectable by the user to a state of being selectable by the user.

According to the above configuration, it is possible to increase the usage patterns of the points acquired by the user. In addition, it is possible to provide a structure in which, for example, the first reward is made acquirable by playing the specific game, so that it is possible to provide the user with motivation to play the specific game.

### Configuration 2

In Configuration 2 based on Configuration 1 above, a giving period may be set for the first giving condition, and the processor may be configured to give the points if the first giving condition is achieved within the giving period, and update the first reward from the initial state of being unselectable by the user to the state of being selectable by the user, if the first giving condition is achieved within the giving period.

According to the above configuration, since the period during which the reward can be acquired is provided, it is possible to encourage the user to actively play the game during the period.

### Configuration 3

In Configuration 3 based on Configuration 2 above, when the giving period elapses, any game may be newly set as the specific game, and the first reward corresponding to the newly set game may be newly set.

According to the above configuration, the first giving condition, the game corresponding to the first giving condition, and the rewards are replaced regularly or irregularly. Therefore, it is possible to encourage the user to play various games.

### Configuration 4

In Configuration 4 based on Configuration 1 above, an amount of points to be given if the first giving condition is achieved may be equal to or larger than an amount of points required in exchange for giving of the first reward.

According to the above configuration, as minimum points to be given, at least points that can be exchanged with one first reward are given, so that the user who wants the first reward can exchange the first reward simply by playing the specific game.

### Configuration 5

In Configuration 5 based on Configuration 4 above, a plurality of the rewards including at least the first reward may be set for the one specific game, and the amount of points to be given if the first giving condition is achieved may be smaller than an amount of points required in exchange for giving of all of the plurality of the rewards.

According to the above configuration, in the case where a plurality of rewards are set for the specific game, points required to acquire all the rewards cannot be obtained simply by achieving the first giving condition. Therefore, it is possible to encourage the user to acquire points by another method, for example, by playing another game.

### Configuration 6

In Configuration 6 based on Configuration 5 above, at least the one first giving condition and one second giving condition that the predetermined second reward set in an initial state of being unselectable is updated to a state of being selectable, may be set for the one specific game.

According to the above configuration, in the case where there are multiple rewards corresponding to the specific game, it is possible to provide the user with a guideline for acquiring the rewards in which all the rewards can be acquired by satisfying the giving conditions in order such as by first achieving the first giving condition and then achieving the second giving condition. Accordingly, it is possible to provide the user with motivation to play the specific game over and over.

### Configuration 7

In Configuration 7 based on Configuration 1 above, a plurality of the first giving conditions and the first rewards respectively corresponding to the first giving conditions may be set for the one specific game, and the processor may be configured to, each time each of the first giving conditions is achieved, update the first reward corresponding to the first giving condition from the initial state to the state of being selectable.

According to the above configuration, it is possible to provide the user with a state where the user needs to play the game to some extent in order to acquire all the rewards corresponding to the specific game, so that it is possible to provide the user with motivation to play the specific game over and over.

### Configuration 8

In Configuration 8 based on Configuration 1 above, the first rewards may be non-in-game items that cannot be used in the game.

According to the above configuration, items that can be used in the entire system such as an image of a user icon can be provided to the user as rewards, rather than items that can be used directly in the game. Therefore, various giving conditions can be set and presented to the user regardless of the specific contents of each game. Accordingly, it is possible to provide the user with motivation to play various games.

### Configuration 9

In Configuration 9 based on any one of Configurations 1 to 8 above, the processor may be further configured to display the first reward given to another user.

According to the above configuration, it is possible to inform other users of the own reward given status. Conversely, it is also possible to know the reward given statuses of other users, so that it is possible to provide the user with an opportunity to become aware of the existence of the first giving condition that the user is unaware of.

According to the present disclosure, it is possible to increase the usage patterns of the points acquired by the user and to expand the range of choices of rewards that can be acquired by achieving the giving conditions. It is also possible to provide the user with motivation to play the specific game.

### BRIEF DESCRIPTION OF THE DRAWINGS

FIG. 1 is a schematic diagram showing a non-limiting example of the entire configuration of a game system according to an exemplary embodiment;

FIG. 2 is a block diagram showing a non-limiting example of the hardware configuration of a server 1000;

FIG. 3 shows a non-limiting example of the appearance of a game apparatus 1;

FIG. 4 shows a non-limiting example of the hardware configuration of the game apparatus 1;

FIG. 5 is a diagram for describing a non-limiting example of the flow of point exchange in the exemplary embodiment;

FIG. 6 is a diagram for describing a non-limiting example of the flow of point exchange in the exemplary embodiment;

FIG. 7 is a diagram for describing a non-limiting example of an outline of processing in the exemplary embodiment;

FIG. 8 illustrates a memory map showing a non-limiting example of various kinds of data stored in a storage section 1002 of the server 1000;

FIG. 9 shows a non-limiting example of the data structure of a user management database 302;

FIG. 10 shows a non-limiting example of the data structure of a mission management database 303;

FIG. 11 shows a non-limiting example of the data structure of a reward management database 304;

FIG. 12 illustrates a memory map showing a non-limiting example of various kinds of data stored in a storage section 82 of the game apparatus 1;

FIG. 13 is a non-limiting example flowchart showing the details of mission-related processing;

FIG. 14 is a non-limiting example flowchart showing the details of achievement determination processing;

FIG. 15 is a non-limiting example flowchart showing the details of point shop processing; and

FIG. 16 is a non-limiting example flowchart showing the details of reward giving processing.

### DETAILED DESCRIPTION OF NON-LIMITING EXAMPLE EMBODIMENTS

Hereinafter, one exemplary embodiment will be described. FIG. 1 is a schematic diagram showing the entire configuration of an information processing system according to the exemplary embodiment. The information processing system of the exemplary embodiment includes at least one game apparatus 1 and a server 1000. The server 1000 and the game apparatus 1 are configured to be able to communicate with each other via a network such as the Internet.

### Hardware Configuration of Server

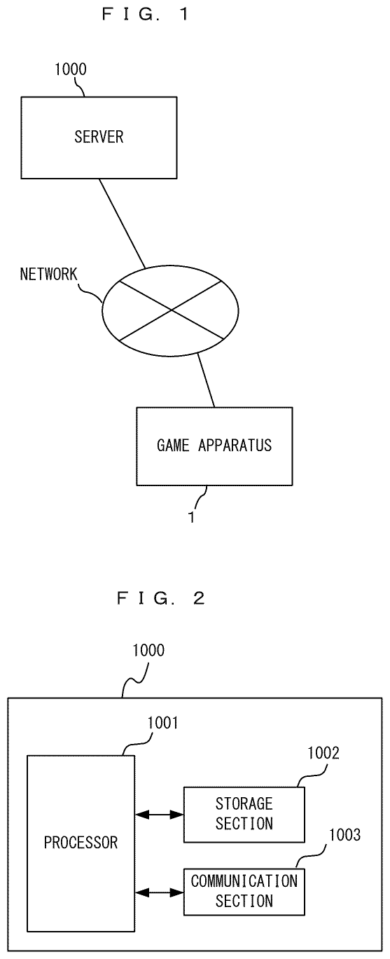

Next, the hardware configurations of the server 1000 will be described. FIG. 2 is a block diagram showing the hardware configuration of the server 1000. The server 1000 includes at least a processor 1001, a storage section 1002, and a communication section 1003. The processor 1001 executes various programs for controlling the server 1000. In the storage section 1002, various programs to be executed by the processor 1001 and various kinds of data to be used by the processor 1001 are stored. The communication section 1003 connects to the network by means of wired or wireless communication and transmits/receives predetermined data to/from the game apparatus 1. In the exemplary embodiment, an example in which there is one server 1000 is illustrated, but the server 1000 may be a single server or may be configured as a group of servers that perform distributed processing.

### Hardware Configuration of Game Apparatus

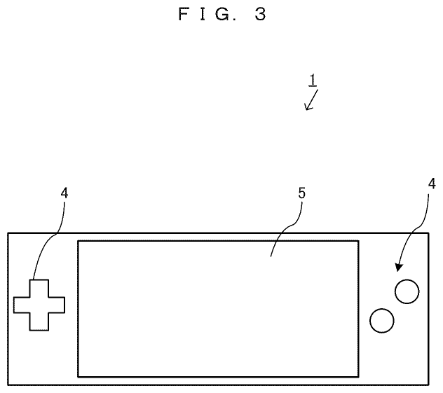

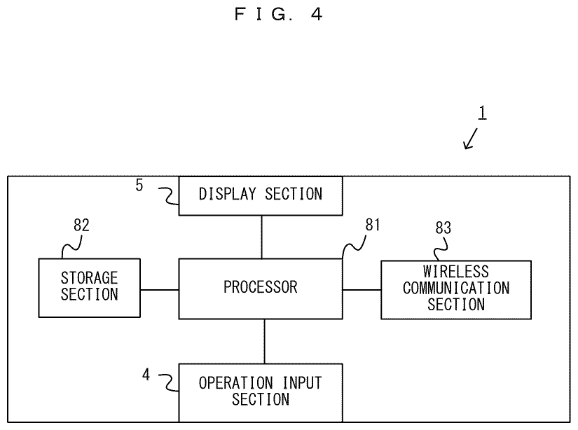

Next, the game apparatus 1 will be described. FIG. 3 shows an example of the appearance of the game apparatus 1 according to the exemplary embodiment. The game apparatus 1 includes an operation input section 4 and a display section 5 (e.g., liquid crystal display). FIG. 4 is a block diagram showing an example of the hardware configuration of the game apparatus 1 according to the exemplary embodiment. In FIG. 4, the game apparatus 1 includes a processor 81. The processor 81 is an information processing section for executing various types of information processing to be executed by the game apparatus 1. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 performs the various types of information processing by executing an information processing program stored in a storage section 82. The storage section 32 may be, for example, an internal storage medium such as a flash memory and a dynamic random access memory (DRAM), or may be configured to utilize an external storage medium mounted to a slot that is not shown, or the like.

The processor 81 also outputs an image and sound generated, for example, by executing the above information processing, to the display section 5.

The game apparatus 1 also includes a wireless communication section 83 for the game apparatus 1 to perform wireless communication with another game apparatus 1 or the above server 1000. As this wireless communication, for example, internet communication or short-range wireless communication is used.

The game apparatus 1 also includes the operation input section 4. The operation input section 4 includes, for example, a direction input device and a plurality of operation buttons.

### Outline of Information Processing in Exemplary Embodiment

Next, an outline of information processing according to the exemplary embodiment will be described. The exemplary embodiment relates to a method for acquiring a “reward” provided as part of services that are available from subscription to a predetermined subscription service. Specifically, by subscribing to the subscription service, games that can be played without paying additional fees are provided to a user. Furthermore, predetermined “giving conditions” regarding predetermined games for which the subscription service is provided are presented to the user on the game apparatus 1. Each giving condition is presented to the user, for example, under the name of “mission”. In the following description, the giving condition is also referred to as “mission”. The mission is not a mission presented as part of game processing in a predetermined game application, but is presented outside of the game processing, such as by the system software of the game apparatus 1. For example, the mission is to “clear up to Stage 3 in a game title A”, or the like. A content that involves game play related to the predetermined game for which the subscription service is provided, is set as the content of the mission. In the exemplary embodiment, points are given to the user when the presented mission is achieved. The user who has been given points can acquire a predetermined reward in exchange for the points owned by the user. That is, by subscribing to the above subscription service, the user can play the predetermined game as much as they want. In addition, the missions related to the game are presented, and points that can be exchanged with a predetermined reward are given when each mission is achieved. Therefore, by playing the game for which the subscription service is provided, the user can obtain opportunities to acquire rewards as described above.

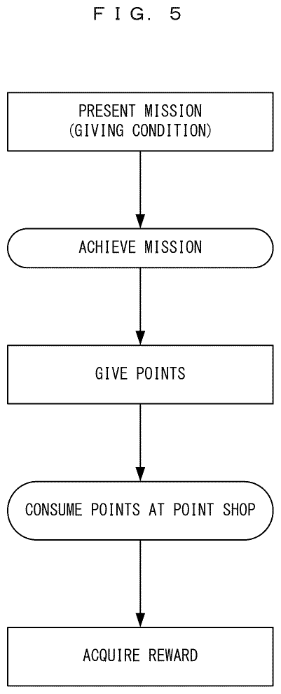

FIG. 5 shows an outline of the flow of reward acquisition in the exemplary embodiment. In the exemplary embodiment, the above missions are presented to the user, and a predetermined amount of points are given to the user when the user achieves each mission using the game apparatus 1. The user can exchange the points with a predetermined reward via, for example, a point shop application (hereinafter referred to as point shop) executed on the game apparatus 1. There are multiple types of such rewards, and a predetermined amount of points required for exchange are set for each reward.

In the information processing system described above, the following processing is further performed in the exemplary embodiment. First, among the above rewards, some rewards are set in advance as rewards that cannot be exchanged unless the user is given a predetermined “item exchange right” in addition to the points. Hereinafter, among the above rewards, a reward that requires the “points” and the “item exchange right” to acquire the reward is referred to as “first-type reward”, and a reward that can be exchanged only with the “points” is referred to as “second-type reward”. In addition, a plurality of rewards can be set as first-type rewards, and the item exchange right is set so as to correspond to each first-type reward, such that, for example, a first-type reward A requires an item exchange right A, and a first-type reward B requires an item exchange right B. In this example, for a user who has been given only the item exchange right B, the first-type reward B can be exchanged if the user has the required points, but the first-type reward A cannot be exchanged even if the user has the required points.

Furthermore, in the exemplary embodiment, among the above missions, some missions are each set such that when the mission is achieved, the above item exchange right is given to the user in addition to the above points. In other words, in order for the user to acquire the item exchange right, the user needs to achieve one mission from among the some missions. For each of the some missions, a condition related to play of a specific game is set as a specific condition for achieving the mission. In the exemplary embodiment, a description will be given with a condition, “activating a specific game title (actually presented to the user as “playing a specific game”), as an example of the condition related to play of the specific game. That is, in order for the user to acquire a specific first-type reward, the user needs to achieve one mission from among the some missions through which an item exchange right corresponding to the specific first-type reward is given. In other words, the user is required to activate the game title specified in the mission. Hereinafter, a mission for which such an achievement condition related to play of the specific game title is set and that allows points and an item exchange right to be given when the mission is achieved, is referred to as “first-type mission”. In addition, a mission other than the first-type mission, that is, a mission that allows only points to be given when the mission is achieved, is referred to as “second-type mission”.

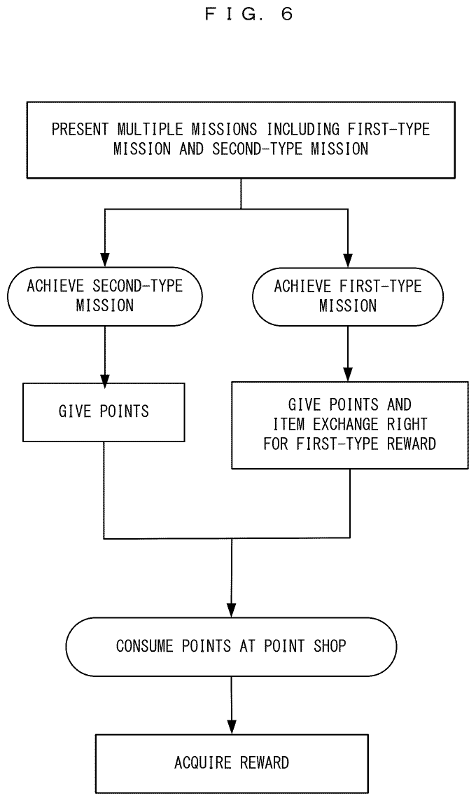

FIG. 6 shows an outline of the flow of point exchange based on the above first-type mission according to the exemplary embodiment. First, a plurality of missions including the above first-type mission and the above second-type mission are presented to the user. If the user achieves the second-type mission, only points are given. Meanwhile, if the user clears a predetermined first-type mission by, for example, activating the “game title A”, the above points and, for example, the item exchange right corresponding to the first-type reward A are given. Then, the user can exchange the second-type reward only by consuming the owned points at the point shop. In addition, since the user has the item exchange right corresponding to the first-type reward A, the user can also acquire the first-type reward A by consuming the points required for the first-type reward A.

In the exemplary embodiment, the first-type reward corresponding to the item exchange right given through the first-type mission is assumed to be a reward having a content corresponding to the above “specific game title” set as the condition for the first-type mission. For example, the first-type reward is an “icon image” that can be used as a user icon on a profile screen or the like and is a face image of the main character of the above specific game title A. In this case, “playing the game title A” is presented as the first-type mission, and the user can achieve the first-type mission by activating the game title A. Then, the user can exchange the icon image which is the face image of the main character of the game title A, in exchange for the required points at the point shop. That is, it is made possible for the user to exchange the first-type reward corresponding to the game title A, by playing the game title A.

In the exemplary embodiment, a system for exchanging points using the first-type mission and the first-type reward as described above is provided. Accordingly, it is possible to provide an incentive to play a specific game title associated with a predetermined first-type mission in order to acquire a specific first-type reward, that is, motivation to play the specific game title. In addition, by preparing a plurality of such first-type missions and a plurality of such first-type rewards, it is possible to provide triggers for playing various games.

The details and specific examples of the above rewards and missions will be described below.

### Details of Rewards

First, the above rewards will be described in more detail. As described above, the first-type rewards are each a reward that requires the required points and the corresponding item exchange right in order to exchange the reward. Therefore, in the initial state where the first-type mission corresponding to the first-type reward has not been achieved, the first-type reward cannot be selected as a reward by the user (even if the user has the required points). Meanwhile, the second-type rewards are each a reward for which no exchange requirement other than the above points is set. In addition, the required point amount is set for each of the first-type reward and the second-type reward.

As for the specific contents of the rewards, in the exemplary embodiment, both the first-type rewards and the second-type rewards are not “in-game items” that can be used in predetermined game processing (during game play), but are “non-in-game items” that cannot be used in the game. For example, the first-type rewards and the second-type rewards are various images that can be used as materials for the above user icon which can be displayed on a home screen of the game apparatus 1, wallpaper that can be set on the home screen, and the like. The images that can be used as materials for the user icon are, for example, a face image of a predetermined character, a background image, and a frame image. One user icon image can be generated by combining these three types of images. In addition, physical objects including various goods such as stuffed toys may be set as rewards.

In the exemplary embodiment, each first-type reward is assumed to be related to the specific game title specified in the first-type mission through which the corresponding item exchange right is given as described above. Meanwhile, each second-type reward may have a content related to the specific game title, or may not necessarily be related to the specific game title.

As described above, each first-type reward is a reward that requires, in effect, achievement of the first-type mission in order to exchange the reward. In contrast, each second-type reward may be a reward that can be exchanged, without particularly achieving a predetermined mission, as long as the user has the required points. Alternatively, each second-type reward may be made exchangeable by achieving a second-type mission for which a condition different from that of the first-type mission is set. An example of the second-type mission in this case is “having played a predetermined number of types of games or more” or the like. That is, the second-type mission may be a mission that is not a condition that specifies a certain individual specific game title.

### Details of Missions

Next, the above missions will be described in more detail. As described above, each first-type mission is a mission that allows the above points and the item exchange right corresponding to a predetermined first-type reward to be given when the mission is achieved. In addition, as described above, a condition regarding play of a specific game is set for the first-type mission. Here, the “condition regarding play of a game” is a condition that can be achieved as a result of certain game processing, including at least activating a game title. For example, in addition to activating the game as described above, clearing a predetermined stage in the specific game title, defeating a predetermined number of enemy characters, etc., may be set as the condition.

Each second-type mission is a mission that allows only points to be given when the mission is achieved as described above. For the second-type mission, association with a specific game may be set or may not necessarily be set. As an example of the second-type mission associated with a specific game, a second-type mission with a condition “defeating an enemy character X in the game title A” may be set. In addition, a condition in the case of being not associated with a specific game title may be, for example, playing a game of a predetermined genre, e.g., an online-compatible game, playing an action game a specified number of times, etc.

Both the first-type missions and the second-type missions may each be set such that a period in which the mission is presented to the user is limited. That is, a valid period may be set for each mission. In the exemplary embodiment, by at least changing, every month, the game title that is to be the target of the first-type mission, the mission is presented to the user as “monthly mission” such that the content of the mission changes. For example, a first-type mission of “playing the game title A” is presented as “April mission”, and in May, this mission is deleted and a first-type mission of “playing a game title B” is presented as “May mission”. In addition, with such a change in the game title that is to be the target of the first-type mission, that is, with a change in the first-type mission, the corresponding first-type reward is also changed from month to month. In the case of such a configuration, it is possible to provide motivation to play the specific game title within the valid period. In addition, a mission for which a valid period is set and a mission for which a period to be presented is not limited may be presented together to the user. For example, it may be possible for the user to acquire the above points at any time by achieving the second-type mission (permanent type mission) not included in the “monthly missions”.

Here, in the case where a valid period is set for each first-type mission, an

exchangeable period may be provided for the first-type reward corresponding to each first-type mission. In this case, the exchangeable period for the first-type reward may be equal to the valid period for the first-type mission or may be longer than this period, but in either case, the exchangeable period itself may be limited. For example, as for the first-type reward corresponding to the first-type mission presented as “April mission”, the exchangeable period therefor may be during April. In this case, for example, when “April mission” is switched to “May mission”, the first-type reward corresponding to the first-type mission presented as “April mission” becomes unselectable at the point shop. That is, even if this first-type mission has been achieved in April, the corresponding first-type reward is deleted from an exchange lineup in May. Also, for example, as for the first-type reward corresponding to the first-type mission presented as “April mission”, the exchangeable period therefor may be during May. In this case, when “April mission” is switched to “May mission”, a user who has already satisfied a first giving condition as the first-type mission in

April may continue to be able to select the first-type reward during May. That is, if the first-type mission has been already achieved in April, the first-type reward does not disappear from the exchange lineup immediately after the month changes. In this case, to a user who has not achieved the first-type mission in April, the corresponding first-type reward is not presented at the point shop in May. This is because this user does not have the item exchange right for the first-type reward and there is no opportunity to acquire the item exchange right due to the elapse of the valid period for the corresponding first-type mission. Therefore, even if the user plays the game corresponding to the first-type mission in May, no points and no item exchange right are given by achievement of the first-type mission. In other words, in the case where the exchangeable period is set longer than the valid period for the first-type mission, control is performed such that, in a reward lineup presented at the point shop after the valid period elapses, the corresponding first-type reward is presented only when the corresponding item exchange right has been given to the user.

In addition, not only one mission but also a plurality of missions may be set for one game title. In other words, a game title that is especially desirable for users is especially wanted to play is determined in advance for each month, and a first-type mission and a second-type mission are set for each game title. These missions may be presented to the user as “monthly missions” in a manner in which the missions are distributed from the server 1000 to the game apparatus 1. In particular, when a plurality of missions are presented to the user for a certain game title as “monthly missions”, at least one of the missions may be the above first-type mission.

Next, the relationship between the amount of points to be given when the mission is achieved and the required amount of points set for each reward will be described. The amount of points to be given when the mission is achieved may be equal to the required amount of points required to exchange one first-type reward, or may be larger than the required amount of points. For example, it is assumed that only one first-type reward corresponding to a certain first-type mission is prepared. Then, if the required amount of points is 10 points, the amount of points to be given when the first-type mission is achieved may be 10 points or more. It is also assumed that, for example, five first-type rewards corresponding to a certain game title are prepared. For each of these five first-type rewards, the required amount of points is 10 points, and 50 points are needed to exchange all the five first-type rewards. In this case, an item exchange right for these five first-type rewards may be given when one first-type mission is achieved. In this case, the amount of points acquired through the first-type mission may be an amount of points that is equal to or larger than the required amount of points required to exchange one first-type reward and that is smaller than the total required amount of points required to exchange all the first-type rewards. For example, the amount of points acquired through the first-type mission may be 10 points. In this case, assuming that the user has 0 points, only 10 points are given when the first-type mission is achieved. As a result, only one of the above five first-type rewards is made exchangeable. In this case, in order to acquire all the first-type rewards, the user needs to acquire the missing points by achieving other missions. Accordingly, it is possible to provide the user with motivation to achieve missions (e.g., second-type missions) other than the first-type missions and play various games.

Next, the details of the information processing according to the exemplary embodiment will be described.

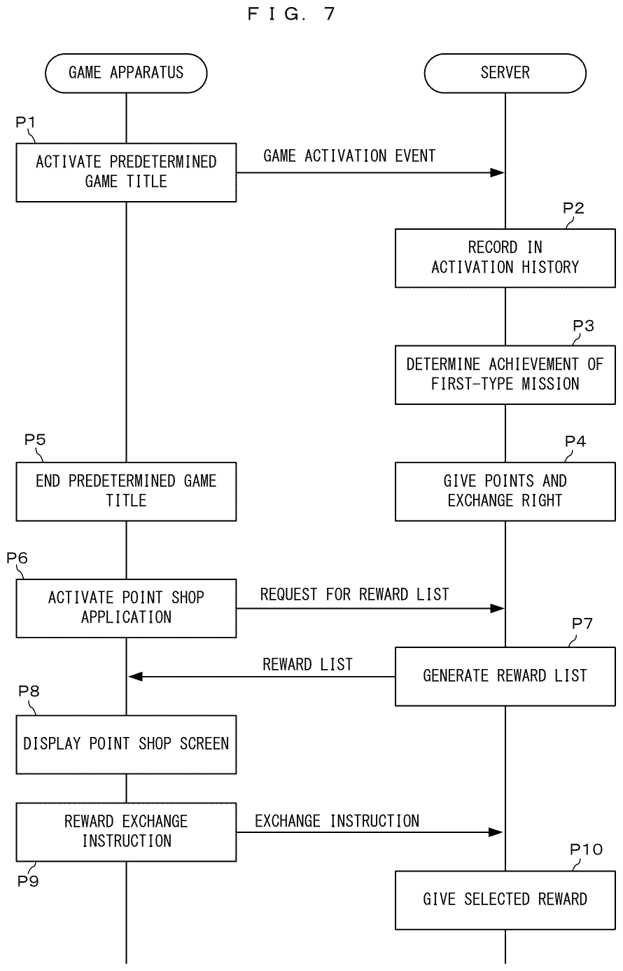

First, an overall outline of processing in the game apparatus 1 and the server 1000 related to the above first-type mission and first-type reward will be described with reference to FIG. 7. In FIG. 7, the left side shows an outline of main processing in the game apparatus 1, and the right side shows an outline of main processing in the server 1000. In the exemplary embodiment, a description will be given with the case of “activating a specific game title” as an example of the specific content of the first-type mission as described above.

In FIG. 7, first, an operation for activating a predetermined game title (here, a game title related to a first-type mission) is performed on the game apparatus 1 (P1). At this time, the game apparatus 1 transmits, to the server 1000, information called a “game activation event” including information identifying the activated game title (e.g., game title ID), the activation date and time, and a user ID. The server 1000 receives the “game activation event” and records the “game activation event” as a game title activation history for the corresponding user (P2). Next, on the basis of the history of the above “game activation event” and data in which the contents of the above “monthly missions” are set and which is stored in the server 1000, the server 1000 determines whether or not any first-type mission in the valid period has been achieved (P3). Furthermore, if there is an achieved first-type mission, the server 1000 performs a process of giving points set for the first-type mission and the above exchange right to the user (P4). Specifically, the contents of user data stored in the server 1000 as described later are updated to reflect the giving.

Next, the game apparatus 1 ends the above predetermined game title (P5) and then activates the point shop (P6). When the point shop is activated, the game apparatus 1 requests a reward list presented at the point shop from the server 1000. In response to the request, the server 1000 generates a shop reward list corresponding to the requesting user (P7). For example, if the user has achieved the first-type mission, a shop reward list indicating that the corresponding first-type reward is exchangeable is transmitted. The shop reward list includes, for example, lineup information identifying each first-type reward presented in a lineup at the point shop in that month (e.g., a reward ID 342 described later) and exchangeability information indicating whether the first-type reward is exchangeable or not exchangeable. The exchangeability information can be set to have different contents for each user on the basis of the points owned by each user and whether or not each user has the item exchange right.

The game apparatus 1 generates and displays a screen related to the point shop on the basis of the shop reward list (P8). At this time, the first-type rewards that are not exchangeable are presented so as to be included in the reward lineup, but are, for example, grayed out such that it is recognized that the first-type rewards are not exchangeable. Then, the game apparatus 1 accepts an exchange instruction operation from the user and transmits information on the first-type reward selected by the user, to the server 1000 (P9). The server 1000 performs a process of giving the selected first-type reward to the user (updating the user data (P10)).

As described above, in the exemplary embodiment, the activation date and time of the game title are stored in the server 1000 as a history for determination of achievement of the first-type mission. Then, the server 1000 performs a process of determining whether or not the first-type mission has been achieved, on the basis of the game title specified by the first-type mission, the valid period therefor, and this history information, and giving the points and the item exchange right to the user.

Next, various kinds of data used in each of the server 1000 and the game apparatus 1 and processing performed in each of the server 1000 and the game apparatus 1 will be described in more detail.

### Data Used in Server 1000

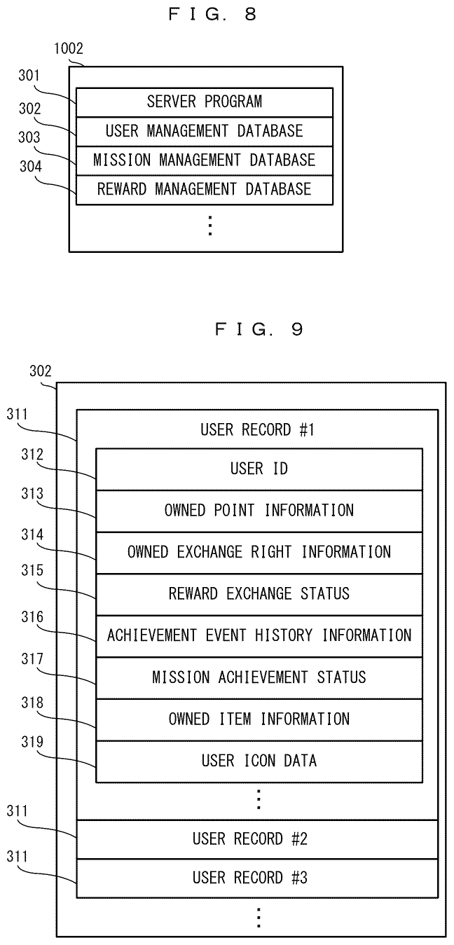

First, the data used in the server 1000 will be described. FIG. 8 illustrates a memory map showing an example of various kinds of data stored in the storage section 1002 of the server 1000. In the storage section 1002 of the server 1000, at least a server program 301, a user management database 302, a mission management database 303, and a reward management database 304 are stored.

The server program 301 is a program for executing various types of server processing such as determining achievement of the above missions.

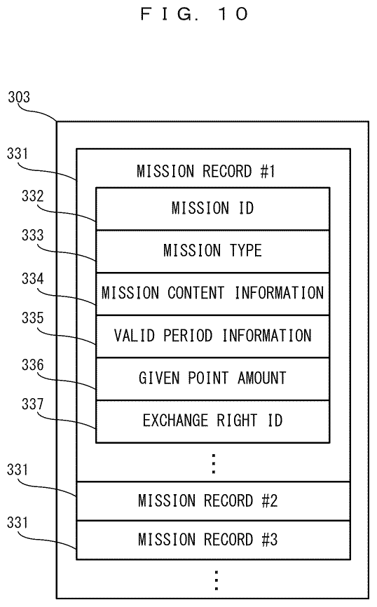

The user management database 302 is a database for managing the above users. FIG. 9 shows an example of the data structure of the user management database 302. The user management database 302 includes a plurality of user records 311. Each user record 311 includes a user ID 312, owned point information 313, owned exchange right information 314, a reward exchange status 315, achievement event history information 316, a mission achievement status 317, owned item information 318, user icon data 319, etc.

The user ID 312 is an ID for uniquely identifying each user. The owned point information 313 is data showing the amount of points owned by the user. The owned exchange right information 314 is data showing the above item exchange right (exchange right ID 337 described later) given to the user. The reward exchange status 315 is a reward exchange history recorded for the user. The achievement event history information 316 is various “achievement events” achieved by the user which are recorded as a history. The achievement events are a concept that includes not only the above “game activation events” but also the results of predetermined game processing achieved other than game activation events, such as “having defeated a predetermined number of enemy characters in a predetermined game” and “having advanced to a predetermined stage in a predetermined game”. That is, the achievement event history information 316 is various “achievements” accomplished by the user in predetermined game play which are recorded as a history. If the “achievement events” are “game activation events”, as a result, an activation history of the game titles activated by the user (the game apparatus thereof) is recorded. In addition, it does not matter whether or not the “achievement events” are set as the above various missions. The achievement event history information 316 is certain “achievements” accomplished on the game apparatus 1 which are simply recorded as a history. The achievement event history information 316 is configured such that at least data for a period longer than the valid period for the above mission and the reward exchangeable period can be held therein, and is configured such that, for example, a history of “achievement events” in past several months is held therein. The mission achievement status 317 is data in which a history of specific missions achieved by the user and the achievement dates and times are recorded. That is, the mission achievement status 317 is information indicating achieved missions. The owned item information 318 is data indicating the rewards owned by the user, that is, data indicating exchanged rewards. The user icon data 319 is data of an image currently used as a user icon by the user.

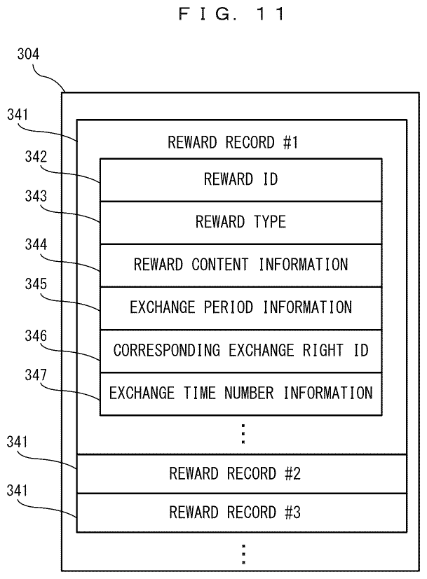

Referring back to FIG. 8, the mission management database 303 is a database for managing the various missions described above. FIG. 10 shows an example of the data structure of the mission management database 303. The mission management database 303 includes a plurality of mission records 331. Each mission record 331 includes a mission ID 332, a mission type 333, mission content information 334, valid period information 335, a given point amount 336, the exchange right ID 337, etc. The mission ID 332 is an ID for uniquely identifying each mission. The mission type 333 is information for distinguishing whether the mission is the above first-type mission or second-type mission. The mission content information 334 is data in which a specific condition content of the mission is set. The valid period information 335 is data indicating the valid period of the mission, that is, the period during which the mission is presented to the user. The given point amount 336 is data indicating the amount of exchange points to be given when the mission is achieved. The exchange right ID 337 is an ID for, if the mission is a first-type mission, identifying an exchange right to be given to the user when the mission is achieved.

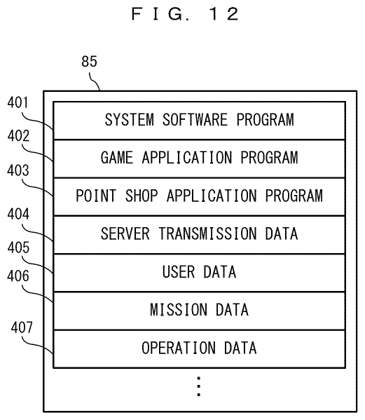

Referring back to FIG. 8, the reward management database 304 is a database for managing the various rewards described above. FIG. 11 shows an example of the data structure of the reward management database 304. The reward management database 304 includes a plurality of reward records 341. Each reward record 341 includes the reward ID 342, a reward type 343, reward content information 344, exchange period information 345, a corresponding exchange right ID 346, exchange time number information 347, etc. The reward ID 342 is an ID for uniquely identifying each reward. The reward type 343 is information for distinguishing whether the reward is the above first-type reward or second-type reward. The reward content information 344 is data indicating the specific content of the reward. The exchange period information 345 is data indicating the period during which the reward is exchangeable. In the case of a reward for which an exchangeable period is not specified, information indicating that an exchangeable period is not specified is set. The corresponding exchange right ID 346 is set to the exchange right ID 337 required for exchange if the reward is a first-type reward. That is, the corresponding exchange right ID 346 is information that associates the first-type reward with the first-type mission. The exchange time number information 347 is data indicating the number of times the reward can be exchanged by one user (number of rewards).

The contents of the mission management database 303 and the reward management database 304 can be updated as appropriate. For example, assuming the above “monthly mission”, each time the month changes, the mission management database 303 is updated with a content indicating each mission for the month. Similarly, the reward management database 304 is updated so as to include a reward corresponding to a mission for the month after the change.

In addition, various kinds of transmission data to be transmitted to the game apparatus 1, such as the above shop reward list, and temporary data required for other server processing, which are not shown, are also generated as necessary and stored in the storage section 1002.

### Data Used in Game Apparatus 1

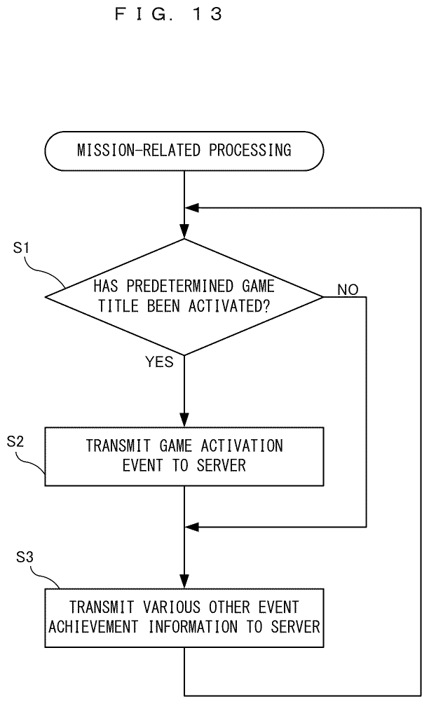

Next, data used in the game apparatus 1 will be described. FIG. 12 illustrates a memory map showing an example of various kinds of data stored in the storage section 82 of the game apparatus 1. In the storage section 82 of the game apparatus 1, for example, a system software program 401, a game application program 402, a point shop application program 403, server transmission data 404, user data 405, mission data 406, operation data 407, etc., are stored.

The system software program 401 is a program for controlling the system of the game apparatus 1. The system software program 401 is also referred to as operation system, firmware, etc.

The game application program 402 is a program for a predetermined game application. The game application program 402 may be installed in the game apparatus 1, or may be read and stored from a predetermined external storage medium such as a game card, for example. In addition, a plurality of such game application programs 402 may be stored. That is, a plurality of game applications may be installed.

The point shop application program 403 is a program for executing the above point shop. The point shop application program 403 is installed in advance as one of the initial applications of the game apparatus 1.

The server transmission data 404 is various kinds of temporarily stored data to be transmitted to the server 1000.

The user data 405 is various kinds of data regarding the above users, acquired from the server 1000. For example, the user data 405 is data copied from the contents of the user records 311.

The mission data 406 is data regarding the above missions, acquired from the server 1000. In the exemplary embodiment, the mission data 406 includes data of the “monthly missions” for the current month and data of permanent type missions.

The operation data 407 is data acquired from the controller operated by the user. That is, the operation data 407 is data indicating the contents of operations performed by the user.

Next, a flowchart example of the information processing in the exemplary embodiment will be described.

### Details 1 of Processing Executed by Processor 81 of Game Apparatus 1

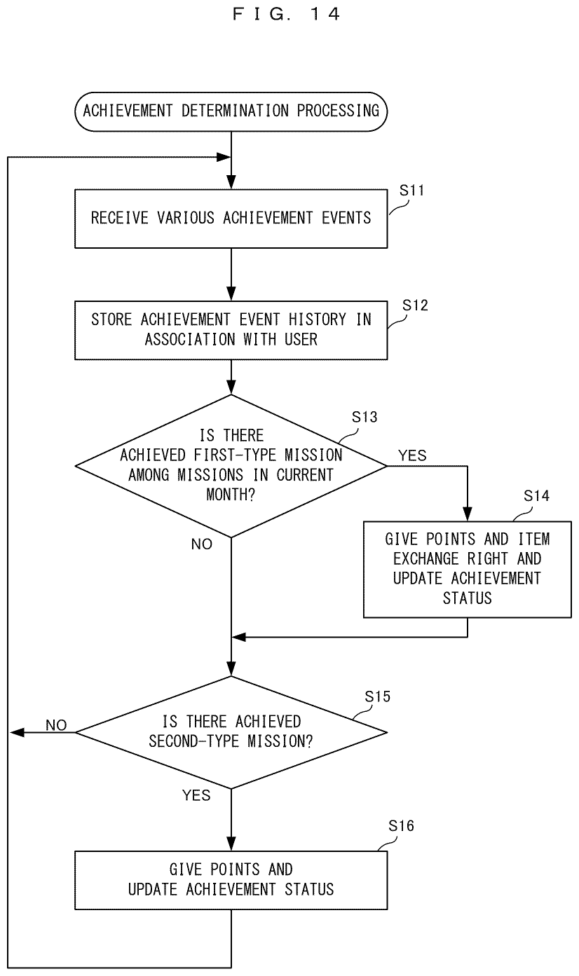

First, processing performed in the game apparatus 1 with respect to achievement of the above missions (hereinafter referred to as mission-related processing) will be described. FIG. 13 is a flowchart showing an example of the mission-related processing. This processing is incorporated as part of the above system software program, and is executed by performing processing of the system of the game apparatus 1. In addition, a process loop of steps S1 to S3 in FIG. 13 is repeated at predetermined time intervals.

First, in step S1, the processor 81 determines whether or not activation of the predetermined game title, that is, the game application program 402, has occurred (an activation event has occurred). It does not matter whether or not the game title corresponds to the first-type mission. If a certain game title is activated, regardless of whether the game title corresponds to the first-type mission, it is determined that activation has occurred. If, as a result of the determination, activation has occurred (YES in step S1), in step S2, the processor 81 transmits the above “game activation event” as the above “achievement event” to the server 1000. Specifically, the processor 81 generates data of the “game activation event” including information identifying the activated game title, the activation date and time of the game title, and the user ID of the user operating the game apparatus 1. Then, the processor 81 includes the generated “game activation event” in the server transmission data 404, and transmits the “game activation event” to the server 1000 as the above “achievement event”.

On the other hand, if activation of the predetermined game title has not occurred (NO in step S1), the process in step S2 above is skipped.

Next, in step S3, the processor 81 transmits various “achievement events” other than the above game activation event to the server 1000. For example, in predetermined race game processing, if the user completes a predetermined course, the processor 81 detects the completion. Any detection method may be used, and, for example, information indicating the completion may be outputted from the game application to the system side of the game apparatus 1, and the output may be detected. If detected, the processor 81 generates data of the “achievement event” including information indicating that the predetermined course has been completed in the race game, the achievement date and time, the user ID, etc. Then, the processor 81 includes the data in the server transmission data 404, and transmits the data to the server 1000 as the “achievement event”. The various “achievement events” are also each detected and transmitted regardless of whether the achievement event corresponds to the second-type mission.

After that, the processor 81 returns to step S1 above and repeats the processing.

### Details 1 of Processing Executed by Processor 1001 of Server 1000

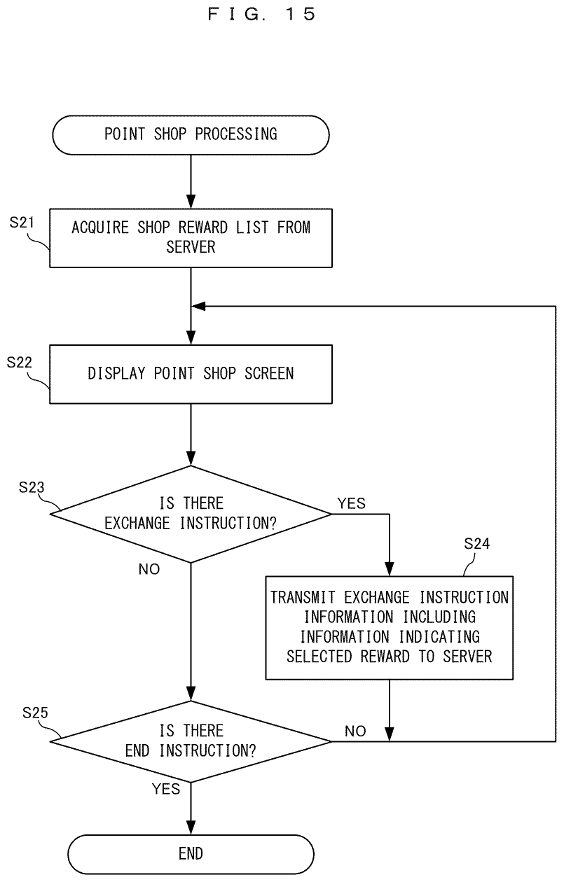

Next, processing performed in the server 1000 with respect to the above missions (hereinafter referred to as achievement determination processing) will be described. FIG. 14 is a flowchart showing an example of the achievement determination processing. A process loop of steps S11 to S16 in FIG. 14 is repeated at predetermined time intervals. In FIG. 14, first, in step S11, the processor 1001 receives the various “achievement events” transmitted from the game apparatus 1.

Next, in step S12, the processor 1001 updates the above achievement event history information 316 in association with the predetermined user on the basis of the information included in the “achievement events”.

Next, in step S13, the processor 1001 refers to the achievement event history information 316 and the mission management database 303, and determines whether or not there is any achieved first-type mission among the valid first-type missions in the current month. That is, it is determined whether or not, among the “game activation events” included in the achievement event history information 316, there is any “game activation event” for which a specific game title is the same as the game title of any one of the unachieved first-type missions and the activation date and time thereof are within the valid period for the first-type mission. If there is such a game activation event, it is determined that there is an achieved first-type mission. If, as a result of the determination, there is no achieved first-type mission (NO in step S13), the processor 1001 advances the processing to step S15 described later. On the other hand, if there is an achieved first-type mission (YES in step S13), in step S14, the processor 1001 identifies the given point amount 336 and the exchange right ID 337 on the basis of the mission record 331 corresponding to this first-type mission. Then, the processor 1001 updates the user record 311 such that the points indicated by the given point amount 336 and the exchange right ID 337 are given to the user. In addition, the processor 1001 also updates the mission achievement status 317 such that it is recognized that the above first-type mission has been achieved.

Next, in step S15, the processor 1001 refers to the achievement event history information 316 and the mission management database 303, and determines whether or not there is any achieved second-type mission. If, as a result of the determination, there is an achieved second-type mission (YES in step S15), in step S16, the processor 1001 updates the user data 405 such that the points corresponding to the achieved second-type mission are given to the user. The processor 1001 also updates the mission achievement status 317 such that it is recognized that the second-type mission has been achieved. Thereafter, the processor 1001 returns to step S11 above and repeats the processing. On the other hand, if no second-type mission has been achieved (NO in step S15), step S16 above is skipped, and the processor 1001 returns to step S11 above.

### Details 2 of Processing Executed by Processor 81 of Game Apparatus 1

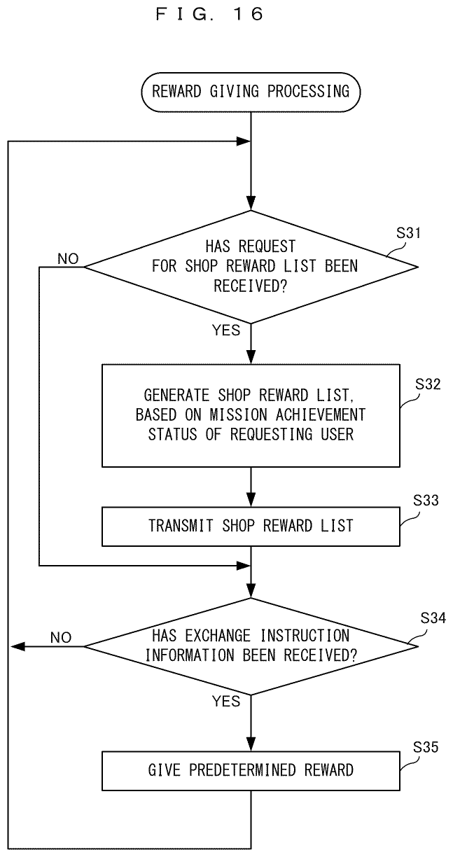

Next, processing in the game apparatus 1 regarding the point shop application (hereinafter referred to as point shop processing) will be described. FIG. 15 is a flowchart showing an example of the point shop processing. Execution of this processing is started, for example, when an operation for activating the point shop application is performed on a predetermined menu screen.

In FIG. 15, first, in step S21, the processor 81 acquires, from the server 1000, a shop reward list including a reward lineup presented at that time and information on rewards, in the lineup, that can be exchanged by the user. Specifically, the processor 81 transmits a request for the shop reward list including the user ID, etc., to the server 1000. Then, the processor 81 receives the shop reward list transmitted from the server 1000 in response to the request.

Next, in step S22, the processor 81 generates and displays a point shop screen on the basis of the shop reward list. On the screen, the reward lineup is displayed on the basis of the shop reward list, and each reward, in the lineup, that cannot be exchanged is displayed in a different manner such that it can be identified that the reward cannot be exchanged. For example, the display portion of the reward is grayed out. In this case, for example, if the reward is a first reward, information indicating the corresponding first-type mission may be displayed as a pop-up by moving a cursor to the display location of the first reward.

Next, in step S23, the processor 81 determines whether or not an exchange instruction operation has been performed for any of the exchangeable rewards, on the basis of the operation data 407. If, as a result of the determination, an exchange instruction operation has been performed (YES in step S23), in step S24, the processor 81 generates server transmission data 404 including information specifying the reward for which the exchange instruction has been performed, and transmits the server transmission data 404 to the server 1000 as exchange instruction information. Thereafter, after receiving, from the server 1000, a notification that the giving of the reward has been completed and a shop reward list updated so as to reflect the giving, the processor 81 returns to step S22 above and repeats the processing.

On the other hand, if, as a result of the determination in step S23 above, there is no exchange instruction (NO in step S23), in step S25, the processor 81 determines whether or not an operation for instructing end of the point shop processing has been performed, on the basis of the operation data 407. If, as a result of the determination, such an operation has not been performed (NO in step S25), the processor 81 returns to step S22 above. If such an operation has been performed (YES in step S25), the processor 81 ends the point shop processing.

### Details 2 of Processing Executed by Processor 1001 of Server 1000

Next, processing in the server 1000 that can be performed in conjunction with the point shop application (hereinafter referred to as reward giving processing) will be described. FIG. 16 is a flowchart showing an example of the reward giving processing. In FIG. 16, first, in step S31, the processor 1001 determines whether or not the above shop reward list request has been received from the game apparatus 1. If, as a result of the determination, the shop reward list request has not been received (NO in step S31), the processor 1001 advances the processing to step S34 described later. If the shop reward list request has been received (YES in step S31), in step S32, the processor 1001 generates the above shop reward list on the basis of the mission achievement status 317 for the user of the game apparatus 1 that has transmitted the request, the mission management database 303, and the reward management database 304. Specifically, the processor 1001 determines the first-type missions and the second-type missions that are valid in the current month, and specifies a reward lineup. Furthermore, the processor 1001 determines the exchangeable first-type rewards and second-type rewards in the lineup, for each user, on the basis of the owned point information 313, the reward exchange status 315, and the mission achievement status 317 of the user and the exchange time number information 347 of each reward. Then, the processor 1001 generates the shop reward list on the basis of the results of these determinations. As described above, each first-type reward is set in a state of being not exchangeable as an initial state, but if the user has a corresponding item exchange right (and has the required points), a shop reward list in which the first-type reward is set to be exchangeable is generated.

Next, in step S33, the processor 1001 transmits the shop reward list to the game apparatus 1 that has transmitted the request.

Next, in step S34, the processor 1001 determines whether or not exchange instruction information has been received from the game apparatus 1. If exchange instruction information has been received (YES in step S34), in step S35, the processor 1001 executes a process of giving the reward specified in the exchange instruction information to the user. Specifically, the processor 1001 executes a process of subtracting the required point amount set for the specified reward from the owned point information 313 and adding the specified reward to the owned item information 318. The processor 1001 also updates the mission achievement status 317 such that, as for the mission achieved this time, it is indicated that this mission has been achieved. The processor 1001 also updates the reward exchange status 315 to keep the content of this exchange as a history. Then, after the giving is completed, the processor 1001 generates the shop reward list reflecting this giving. For example, if a first-type reward for which the number of times the first-type reward can be exchanged is only one is given, a shop reward list in which the first-type reward is set to be non- exchangeable is generated. Then, the processor 1001 transmits a notification that the giving has been completed and the shop reward list to the game apparatus 1. Thereafter, the processor 1001 returns to step S31 above and repeats the processing.

On the other hand, if, as a result of the determination in step S34 above, no exchange instruction information has been received (NO in step S34), step S35 above is skipped, and the processor 1001 returns the processing to step S31.

This is the end of the detailed description of the processing in the game apparatus 1 and the server 1000 in the exemplary embodiment.

As described above, in the exemplary embodiment, by subscribing to the subscription service, the user can play the predetermined games without paying additional fees. In addition, the missions related to the games for which the subscription service is provided are presented to the user such that, for example, the contents thereof are changed on a “monthly basis”. Then, points are given to the user when each mission is achieved, and a non-in-game item is given to the user as a reward in exchange for the points. As for the rewards, two types of rewards, the first-type rewards and the second-type rewards described above, are set. As for the above missions, two types of missions, the second-type missions through which only points are given and the first-type missions through which an exchange right for a predetermined first-type reward is given in addition to points, are set. Furthermore, as the condition for each first-type mission, a condition that the first-type mission is achieved when a specific game among the games for which the subscription service is provided is played, is set. Owing to such a configuration, it is possible to encourage the user to play various games for which the subscription service is provided, in order to acquire predetermined rewards. In other words, it is possible to encourage the user to utilize the subscription service. In addition, by changing the specific game associated with the first-type mission on a monthly basis, for example, it is also possible to provide the user with opportunities and triggers for experiencing various games. The points acquired by the user can be exchanged with various rewards, and thus can be used in a variety of ways.

As described above, in the case where a plurality of missions are set for one game, by causing the first-type mission and the second-type mission to coexist, it is possible to induce the user to play the game more deeply. For example, it is assumed that five missions are set for a “game title A” as one example of the monthly missions. Among these missions, one mission is set as a first-type mission, and the other missions are set as second-type missions. For these five missions, one first-type reward and four second-type rewards are also set. The points required for each reward are 10 points, and points to be given through each mission are 10 points. An item exchange right to be given through the first-type mission is an item exchange right for these five rewards. As a specific mission content, a condition of activating the “game title A” is set for the first-type mission. As for the second-type missions, for example, conditions of “clearing Stage 1”, “defeating 10 enemy characters X”, “acquiring an item Y”, and “defeating a boss character Z” are set. With the configuration of causing the first-type mission and the second-type mission (the first-type reward and the second-type reward) to coexist as described above, it is possible to induce the user to play the game more. For example, a user having 0 points owned is assumed. By the user activating the “game title A”, the first-type mission is achieved, the item exchange right for the above five rewards is given, and only points for one of the rewards are given. Then, a situation can be created in which, in order to acquire the remaining rewards, it is necessary to achieve the second-type missions to acquire points. This prevents a situation in which all the rewards are made exchangeable only by activating the game, and also prevents a situation in which no reward is acquired as a result of giving minimum points even though the first-type mission is achieved. Furthermore, in order to acquire all the rewards, the game can require a certain degree of game play to achieve the plurality of second-type missions, such as clearing Stage 1 or defeating a specific boss character, for example. That is, it is possible to induce the user to perform more specific game play than just activating the game.

### Modifications

In the above embodiment, the user icon for which an image exchanged as the first-type reward is used may be displayed to other users in the form of a friend list, for example. In this case, since the user icon for which an image that cannot be used unless the first-type mission is achieved is used can be displayed in a friend list, it is possible to grasp the first-type mission achievement statuses of other users. Conversely, if an icon image unknown to the user is displayed in the friend list, it is possible for the user to notice the existence of the first-type mission through which such an image can be exchanged.

In the case where valid periods are set for the above missions, missions may be presented in combination with different valid periods for the same game title. For example, one first-type mission is set as a “monthly mission”. Meanwhile, a plurality of second-type missions may be set as “weekly missions” for this game title. In addition, the target to be changed on a “monthly basis” may be only a game title, and for each game title, both the first-type mission and the second-type mission may be changed on a “weekly basis”.

As for the above-described first-type mission, the condition of activating the specific game title has been described above as an example of the “condition regarding play of a game”. In this regard, as described above, another condition that can be achieved with play of a game may be set, and as one specific example, a plurality of first-type missions may be set with not only the specific game but also an achievement condition of using a predetermined item in the game. That is, a corresponding reward may be set for each individual in-game item, and an exchange right may be set for each reward. For example, a game in which any one of a plurality of types of weapons can be selected as a weapon with which a player character can be equipped, is assumed. In such a game, the following first-type missions may be set as first-type missions focusing on these weapons. That is, a plurality of first-type missions that require the use of a specific weapon, such as playing a predetermined number of times using a weapon A”, “defeating a predetermined number of enemy characters using a weapon B”, and “winning a predetermined number of matches using a weapon C”, may be prepared. Then, first-type rewards respectively corresponding to these first-type missions may be prepared. As a result, a situation can be created in which, in order to acquire an item exchange right for the first-type reward corresponding to a certain weapon, the user needs to clear a mission using the weapon. Accordingly, it is possible to encourage the user to play using various weapons.

As for the method of determining achievement of the second-type mission described above, in another exemplary embodiment, the following processing may be performed. For example, in the program for each game application, when a predetermined condition regarding game play such as clearing a predetermined stage is satisfied, it is determined that a predetermined “achievement” is accomplished, and data of the “achievement” is outputted from the game application to the system of the game apparatus 1. Then, as processing on the system side of the game apparatus 1, whether or not the second-type mission has been achieved is determined on the basis of the mission data 406. If, as a result of the determination, the second-type mission has been achieved, information identifying the achieved second-type mission may be transmitted to the server 1000. Then, the server 1000 may determine achievement of the second-type mission on the basis of the information identifying the achieved second-type mission.

In the above embodiment, the example of using data that is the exchange right ID 337 has been described as an example of processing. In another exemplary embodiment, such an exchange right ID 337 may not necessarily be used. For example, each of the mission records 331 and the reward records 341 may have data that is “achievement condition information” defining an achievement condition, and the “achievement condition information” of each reward record 341 may be set to be the same as “achievement condition information” for a specific mission.

In the above embodiment, the game apparatus 1 may include a plurality of storages and a plurality of processors. The above game processing may be shared and executed by these storages and processors. In addition, each of the processing in the game apparatus 1 and the processing in the server 1000 may be executed in a distributed system including a plurality of information processing apparatuses.

While the present disclosure has been described in detail, the foregoing description is in all aspects illustrative and not restrictive. It is to be understood that numerous other modifications and variations can be devised without departing from the scope of the present disclosure.

What is claimed is:

1. An information processing system comprising a processor, the processor being configured to:
give points to a user if any of a plurality of giving conditions is achieved by the user;
give a reward selected by the user from among a plurality of rewards, to the user in exchange for the points owned by the user,
the plurality of giving conditions including a first giving condition achieved if a specific game is played,
the plurality of rewards including first rewards set in an initial state of being unselectable, and second rewards selectable without achieving the first giving condition; and
when the first giving condition is achieved, update the first reward corresponding to the specific game among the first rewards from the initial state of being unselectable by the user to a state of being selectable by the user.

2. The information processing system according to claim 1, wherein
a giving period is set for the first giving condition, and
the processor is configured to
give the points if the first giving condition is achieved within the giving period, and
update the first reward from the initial state of being unselectable by the user to the state of being selectable by the user, if the first giving condition is achieved within the giving period.

3. The information processing system according to claim 2, wherein, when the giving period elapses, any game is newly set as the specific game, and the first reward corresponding to the newly set game is newly set.

4. The information processing system according to claim 1, wherein an amount of points to be given if the first giving condition is achieved is equal to or larger than an amount of points required in exchange for giving of the first reward.

5. The information processing system according to claim 4, wherein
a plurality of the rewards including at least the first reward are set for the one specific game, and
the amount of points to be given if the first giving condition is achieved is smaller than an amount of points required in exchange for giving of all of the plurality of the rewards.

6. The information processing system according to claim 5, wherein at least the one first giving condition and one second giving condition that the predetermined second reward set in an initial state of being unselectable is updated to a state of being selectable, are set for the one specific game.

7. The information processing system according to claim 1, wherein
a plurality of the first giving conditions and the first rewards respectively corresponding to the first giving conditions are set for the one specific game, and
the processor is configured to, each time each of the first giving conditions is achieved, update the first reward corresponding to the first giving condition from the initial state to the state of being selectable.

8. The information processing system according to claim 1, wherein the first rewards are non-in-game items that cannot be used in the game.

9. The information processing system according to claim 1, wherein the processor is further configured to display the first reward given to another user.

10. A non-transitory computer-readable storage medium having stored therein an information processing program causing a processor of an information processing system to:
give points to a user if any of a plurality of giving conditions is achieved by the user;
give a reward selected by the user from among a plurality of rewards, to the user in exchange for the points owned by the user,
the plurality of giving conditions including a first giving condition achieved if a specific game is played,
the plurality of rewards including first rewards set in an initial state of being unselectable, and second rewards selectable without achieving the first giving condition; and
when the first giving condition is achieved, update the first reward corresponding to the specific game among the first rewards from the initial state of being unselectable by the user to a state of being selectable by the user.

11. An information processing method for causing a processor of an information processing system to:
give points to a user if any of a plurality of giving conditions is achieved by the user;
give a reward selected by the user from among a plurality of rewards, to the user in exchange for the points owned by the user,
the plurality of giving conditions including a first giving condition achieved if a specific game is played,
the plurality of rewards including first rewards set in an initial state of being unselectable, and second rewards selectable without achieving the first giving condition; and
when the first giving condition is achieved, update the first reward corresponding to the specific game among the first rewards from the initial state of being unselectable by the user to a state of being selectable by the user.

12. An information processing apparatus comprising a processor, the processor being configured to:
give points to a user if any of a plurality of giving conditions is achieved by the user;
give a reward selected by the user from among a plurality of rewards, to the user in exchange for the points owned by the user,
the plurality of giving conditions including a first giving condition achieved if a specific game is played,
the plurality of rewards including first rewards set in an initial state of being unselectable, and second rewards selectable without achieving the first giving condition; and
when the first giving condition is achieved, update the first reward corresponding to the specific game among the first rewards from the initial state of being unselectable by the user to a state of being selectable by the user.
